(19) United States
(12) Patent Application Publication
(10) Pub. No.: US 2012/0243022 A1
(43) Pub. Date: Sep. 27, 2012

(54) IMAGE PROCESSING SYSTEM AND IMAGE PROCESSING CONTROL APPARATUS

(75) Inventor: Tasuku KAMEI, Hachioji-shi (JP)

(73) Assignee: Konica Minolta Business Technologies, Inc., Chiyoda-ku (JP)

(21) Appl. No.: 13/425,679

(22) Filed: Mar. 21, 2012

(30) Foreign Application Priority Data
Mar. 25, 2011 (JP) 2011-068696

(51) Int. Cl. G06F 3/12

(52) U.S. Cl. 358/1.13

(57) ABSTRACT

An image processing system has a plurality of image processing apparatuses for performing RIP of a print job in a distributed manner and an image processing control apparatus that controls the image processing apparatuses. The image processing apparatus has a switching unit for switching the operating mode of the image processing apparatus from a normal mode to a power saving mode. And the image processing control apparatus has a control unit for causing unnecessary image processing apparatuses to switch from the normal mode to the power saving mode depending on the progress status of the print job.

### CROSS-REFERENCE TO RELATED APPLICATION

This application is based on Japanese Patent Application No. 2011-068696 filed on Mar. 25, 2011, the contents of which are incorporated herein by reference.

### BACKGROUND

1. Technical Field

The present invention relates to an image processing system and an image processing control apparatus for performing raster image processing of a print job in a distributed manner by a plurality of image processing apparatuses.

2. Description of Related Art

An image processing system that performs raster image processing (hereinafter referred to as “RIP”) of a print job in a distributed manner by a plurality of image processing apparatuses is known (e.g., Unexamined Japanese Patent Publication No. 2009-214348). According to such an image processing system, one print job is split by page and the RIP of each page is performed in parallel by a plurality of image processing apparatuses so that the time required for the RIP of the print job is reduced.

In the meantime, the importance of power saving of image forming apparatuses such as a MFP (Multi-Function Peripheral) and the likes has been heightening as ever in recent years. The power saving of image forming apparatuses is important not only from the economical standpoint but also from the standpoint of reducing environmental load.

However, as to the image processing system that performs RIP of a print job in a distributed manner by a plurality of image processing apparatuses, no attempt of power saving has been tried so far. Since each image processing apparatus is equipped with hardware devices such as CPU (Central Processing Unit), an image processing system having a plurality of image processing apparatus consumes a substantial amount of electric power simply by keeping each image processing apparatus on a standby condition without performing RIP.

### SUMMARY

The present invention is made in order to solve the problem described above. An object of the present invention is to provide an image processing system and an image processing control apparatus capable of reducing the power consumption in performing RIP of a print job in a distributed manner by a plurality of image processing apparatuses.

To achieve at least one of the abovementioned objects, an image processing system reflecting one aspect of the present invention has a plurality of image processing apparatuses for performing raster image processing of a print job in a distributed manner, and an image processing control apparatus that controls the plurality of image processing apparatuses, wherein each of the image processing apparatuses includes: a switching unit configured to switch the operating mode of the image processing apparatus from a normal mode to a power saving mode whose power consumption is lower than that of the normal mode, and the image processing control apparatus includes: a control unit configured to execute a control for causing unnecessary image processing apparatuses among the plurality of image processing apparatuses to switch from the normal mode to the power saving mode depending on the progress status of the print job.

To achieve at least one of the abovementioned objects, an image processing control apparatus reflecting one aspect of the present invention to be used in an image processing system having a plurality of image processing apparatuses for performing raster image processing of a print job in a distributed manner, and an image processing control apparatus that controls the plurality of image processing apparatuses, wherein the operating mode of the image processing apparatuses is configured to switch from a normal mode to a power saving mode whose power consumption is lower than that of the normal mode, and the image processing control apparatus includes: a control unit for executing a control for causing unnecessary image processing apparatuses among the plurality of image processing apparatuses to switch from the normal mode to the power saving mode depending on the progress status of the print job.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a block diagram showing the overall configuration of an image forming system according to a first embodiment of the present invention.

FIG. 2 is a block diagram showing the configuration of the PCs shown in FIG. 1.

FIG. 3 is a block diagram showing the configuration of the master apparatus of the printer controller shown in FIG. 1.

FIG. 4 is a block diagram showing the configuration of the slave apparatuses of the printer controller shown in FIG. 1.

FIG. 5 is a block diagram showing the configuration of the printer shown in FIG. 1.

FIG. 6 is a diagram for describing the operation of the printer controller.

FIG. 7 is a diagram succeeding FIG. 6.

FIG. 8 is a diagram succeeding FIG. 7.

FIG. 9 is a diagram succeeding FIG. 8.

FIG. 10 is a diagram for describing the power saving effect of the distributed process.

FIG. 11 is a flowchart showing the procedure of the distributed process according to the second embodiment of the present invention.

FIG. 12 is a flowchart showing the procedure of the output process according to the second embodiment of the present invention.

FIG. 13 is a flowchart showing the procedure of the image data reception process executed by the master apparatus.

FIG. 14 is a flowchart showing the procedure of the RIP process executed by the slave apparatuses.

FIG. 15 is a diagram showing an example of the changes of the number of remaining pages in the distributed process according to the second embodiment of the present invention.

FIG. 16 is a flowchart showing the procedure of the distributed process according to the third embodiment of the present invention.

FIG. 17 is a flowchart showing the procedure of the output process according to the third embodiment of the present invention.

### DETAILED DESCRIPTION

The embodiments of the present invention will be described below with reference to the accompanying drawings.

### First Embodiment

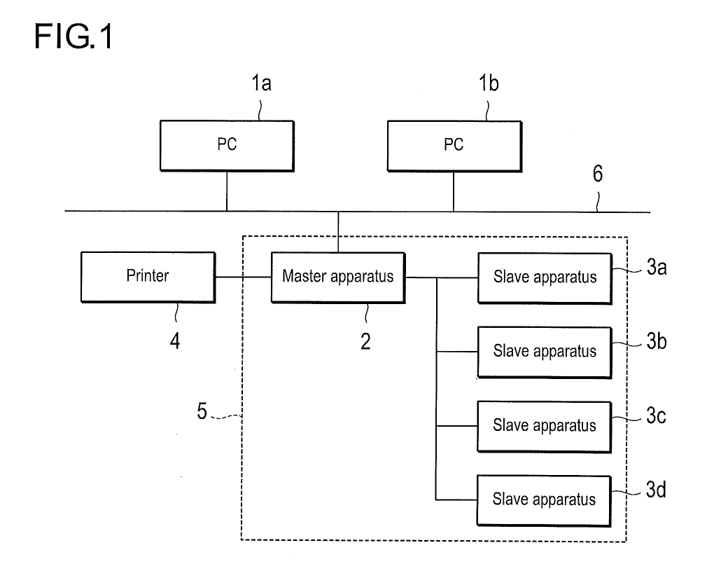

FIG. 1 is a block diagram showing the overall configuration of an image forming system according to a first embodiment of the present invention.

The image forming system according to the present embodiment has PCs (personal computers) 1a, 1b as client apparatuses, a printer controller 5 as an image processing system, and a printer 4 as an image forming apparatus. The PCs 1a, 1b and the printer controller 5 are connected to communicate with each other via a network 6. The network 6 consists of a LAN (Local Area Network) that connects computers and network equipment with each other based on standards such as Ethernet, TokenRing, and FDDI (Fiber Distributed Data Interface), or a WAN (Wide Area Network) that connects LANs via dedicated lines, etc. The printer controller 5 is a blade server equipped with a master apparatus 2 and a plurality of slave apparatuses 3a-3d. The master apparatus 2 and the plurality of slave apparatuses 3a-3d are connected to communicate with each other via a network such as a LAN. The master apparatus 2 is locally connected with the printer 4 via a dedicated circuit. The types and quantities of equipment to be connected to the network 6 are not limited to the example shown in FIG. 1.

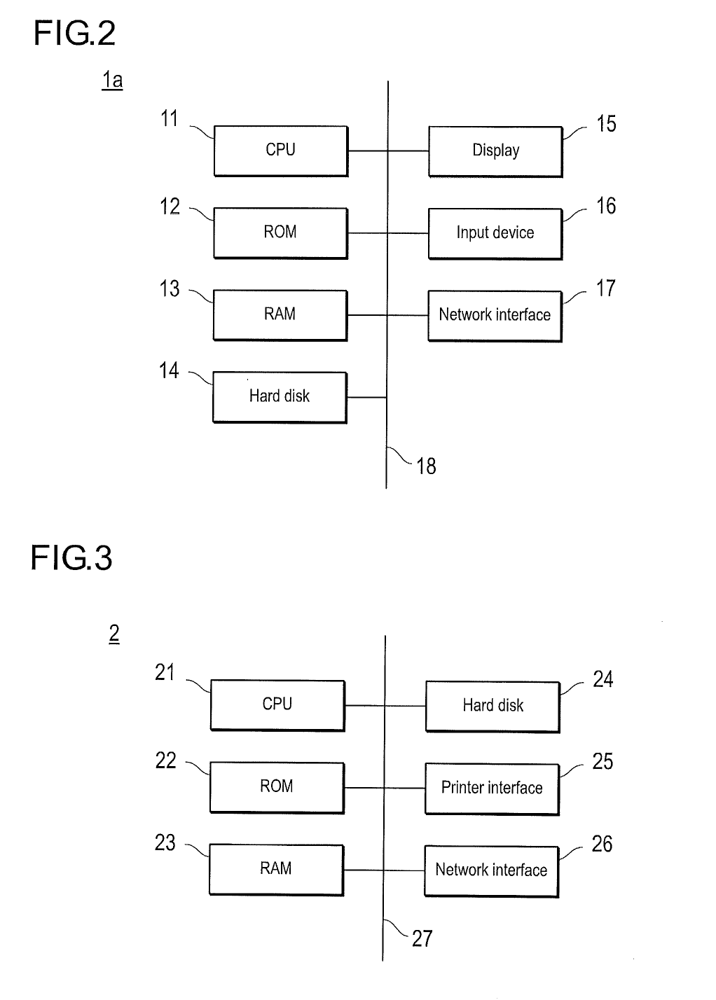

FIG. 2 is a block diagram showing the configuration of the PCs shown in FIG. 1. The PCs 1a, 1b are constituted identical with each other, the PC 1a is used for describing them as a typical one.

The PC 1a has a CPU 11, a ROM (Read Only Memory) 12, a RAM (Random Access Memory) 13, a hard disk 14, a display 15, an input device 16, and a network interface 17, all of which are connected with each other via a bus 18 to exchange signals.

The CPU 11 controls various units described above and executes various arithmetic processes according to a program. The ROM 12 stores various programs and various kinds of data. The RAM 13 temporarily stores programs and data as a work area. The hard disk 14 stores various programs including the operating system (OS) and various kinds of data. The hard disk 14 is installed with a document file preparation application for preparing document files, and a printer driver for converting the document files into print data described in a page description language (PDL) that the printer controller 5 can understand.

The display 15 is typically a liquid crystal display, and is used for displaying various kinds of information. The input device 16 includes a pointing device such as a mouse or a keyboard, and is used for executing various inputs. The network interface 17 is an interface for communicating with other kinds of equipment via the network 6, in which standards such as Ethernet, Token Ring and FDDI are used.

FIG. 3 is a block diagram showing the configuration of the master apparatus of the printer controller shown in FIG. 1.

The master apparatus 2 has a CPU 21, a ROM 22, a RAM 23, a hard disk 24, a printer interface 25, and a network interface 26, all of which are connected with each other via a bus 27 to exchange signals. In order to avoid redundancy, the description of those units amongst the above-mentioned units of the master apparatus 2 having the identical functions as those of the PC 1a is omitted here.

The hard disk 24 is stored with a program for transmitting the print data received from the PCs 1a, 1b to the slave apparatuses 3a-3d by splitting it by page, a program for transferring the image data received from the slave apparatuses 3a-3d to the printer 4, and a program for transmitting a job completion notice to the salve apparatuses 3a-3d.

The printer interface 25 is an interface for communicating with the locally connected printer 4.

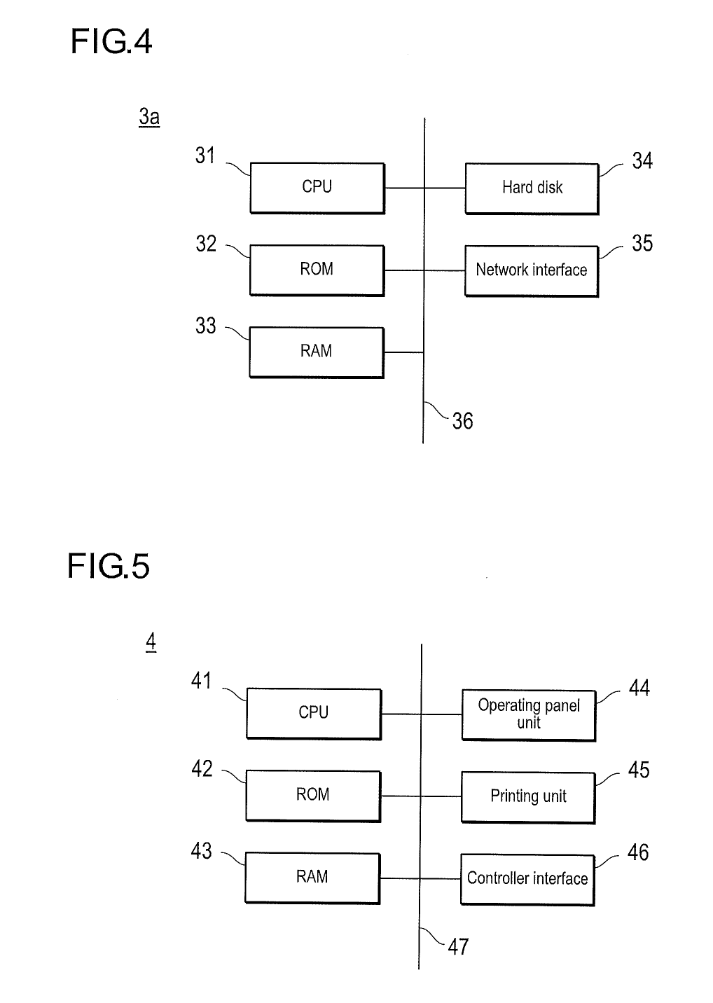

FIG. 4 is a block diagram showing the configuration of the slave apparatuses of the printer controller shown in FIG. 1. The slave apparatuses 3a-3d are constituted identical with each other, the slave apparatus 3a is used for describing them as a typical one.

The slave apparatus 3a has a CPU 31, a ROM 32, a RAM 33, a hard disk 34, and a network interface 35, all of which are connected with each other via a bus 36 to exchange signals. In order to avoid redundancy, the description of those units amongst the abovementioned units of the slave apparatus 3a having the identical functions as those of the PC 1a is omitted here.

The hard disk 34 is stored with a RIP program for translating the print data received from the master apparatus 2 to develop it into image data of the bitmap format, and a program for switching to the power saving mode when a job completion notice is received from the master apparatus 2.

FIG. 5 is a block diagram showing the configuration of the printer shown in FIG. 1. The printer 4 has a CPU 41, a ROM 42, a RAM 43, an operating panel unit 44, a printing unit 45, and a controller interface 46, all of which are connected with each other via a bus 47 to exchange signals. In order to avoid redundancy, the description of those units amongst the abovementioned units of the printer 4 having the identical functions as those of the PC 1a is omitted here.

The ROM 42 is stored with a program of an image forming process to be executed based on the image data received from the printer controller 5.

The operating panel unit 44 is equipped with a touch panel, a ten-key pad, start button, stop button, etc., and is used for displaying various kinds of information and entering various instructions.

The printing unit 45 prints the image based on the image data received from the printer controller 5 on a recording media such as a sheet of paper using the publicly known imaging process, e.g., the electronic photographing process, etc. The controller interface 46 is an interface for communicating with the locally connected printer controller 5.

The PCs 1a, 1b, the master apparatus 2, the slave apparatuses 3a-3d, and the printer 4 may each include components other than those components mentioned above or may lack a portion of those components mentioned above.

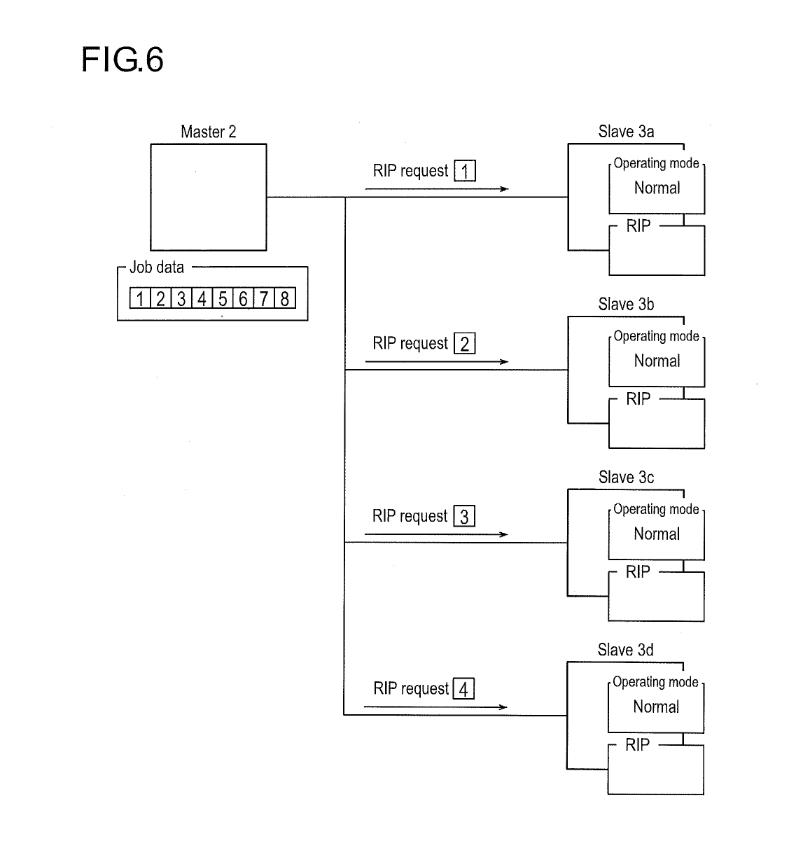

The image forming system of the present embodiment configured as described above performs the RIP of a print job in a distributed manner by the plurality of slave apparatuses 3a-3d, when the print job is loaded into the printer controller 5. At this time, unnecessary slave apparatuses are switched into the power saving mode depending on the progress status of the print job. The operation of a printer controller 5 of the present embodiment will be described below with reference to FIGS. 6 through 9.

FIGS. 6 through 9 are the diagrams for describing the operation of a printer controller 5 of the present embodiment. In the following, a case where the RIP of a print job consisting of 8 pages is performed in a distributed manner by four slave apparatuses will be described as an example.

Prior to the execution of the distributed process, the master apparatus 2 receives the print job from the PC 1a. Upon receiving the print job, the master apparatus 2 analyzes the print job and recognizes the total number of pages (8 pages in this case) of the print job.

First, the master apparatus 2 transfers the data (PDL data) of the first page through the fourth page to the four slave apparatuses 3a-3d respectively and instructs them to perform RIP, as shown in FIG. 6. Upon receiving the data, the four slave apparatuses 3a-3d start to perform RIP. The time that each slave apparatus needs to complete RIP varies with the contents of a page. The slave apparatus that has completed RIP transmits the image data obtained by performing RIP to the master apparatus 2.

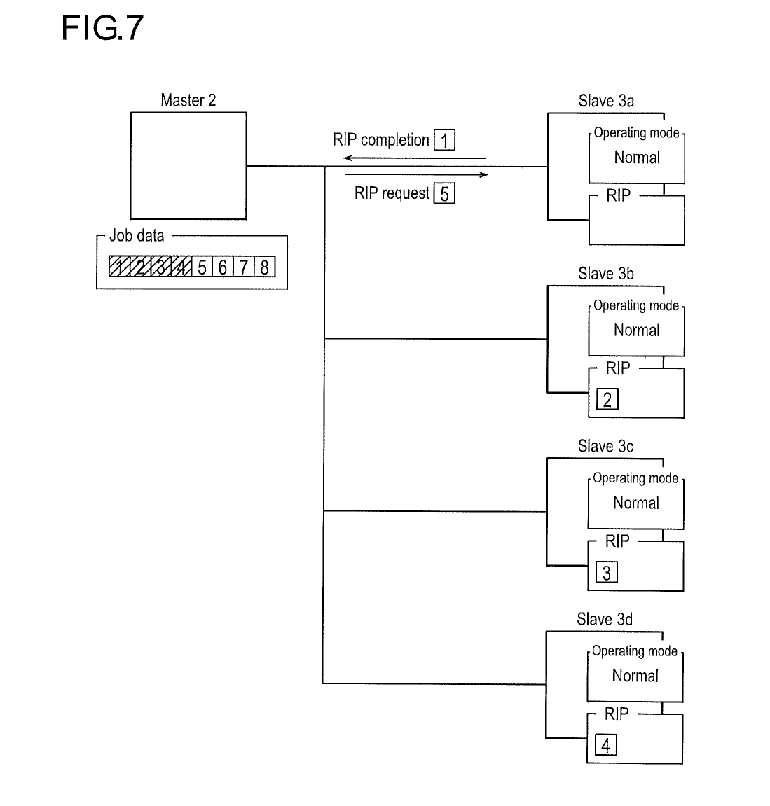

Upon receiving the image data from a slave apparatus that has completed RIP, the master apparatus 2 transmits the data of the next page to the salve apparatus and instructs it to perform RIP. For example, upon receiving the image data of the first page from the first slave apparatus 3a, the master apparatus 2 transmits the data of the fifth page to the first salve apparatus 3a and instructs it to perform RIP (see FIG. 7). The process of transmitting the data of the next page to a slave apparatus that has completed RIP is repeated until the process reaches the last page of the print job.

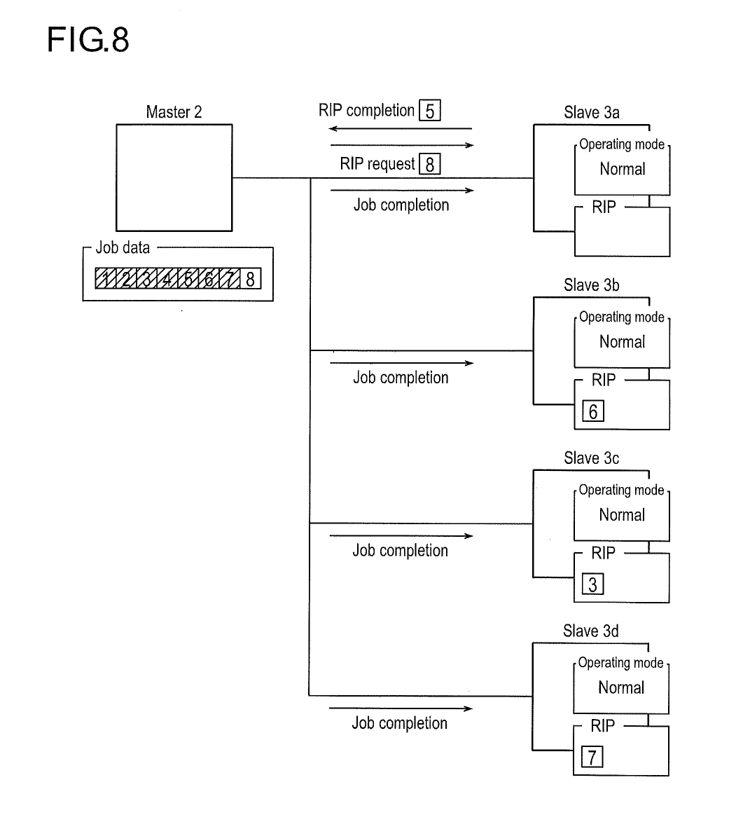

Then, the master apparatus 2 transmits the job completion notice to all the slave apparatuses 3a-3d, when it transmits the data of the last page of the print job to a slave apparatus. For example, the master apparatus 2 transmits the job completion notice to all the slave apparatuses 3a-3d, when it transmits the data of the eighth page to the first slave apparatus 3a (see FIG. 8).

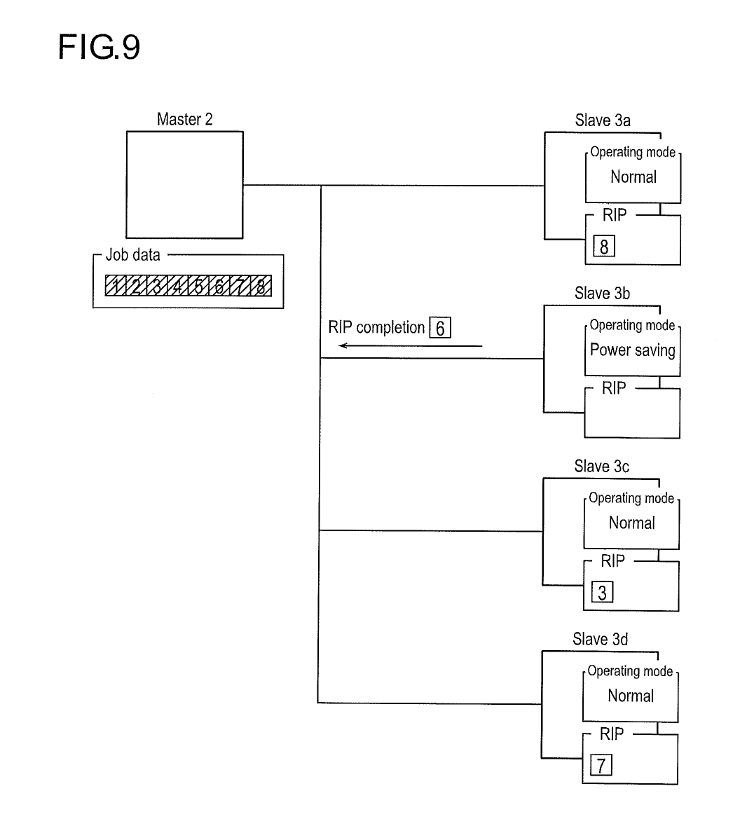

Upon receiving the job completion notice, each of the slave apparatuses 3a-3d switches to the power saving mode after completing the RIP currently being performed. For example, the second slave apparatus 3b switches from the normal mode to the power saving mode when it completes the RIP of the sixth page (see FIG. 9). Similarly, the remaining slave apparatuses 3a, 3c, 3d switch to the power saving mode in sequence as each of them completes the RIP currently being performed.

As the operating mode switches from the normal mode to the power saving mode, the power supply to the CPU 31 provided on each slave apparatuses 3a-3d is suspended. While the slave apparatuses 3a-3d are in the power saving mode, the electric power is supplied on their RAM 33 and the network interface 35, so that they can return to the normal mode when they receive an instruction from the master apparatus 2. The normal mode includes the status of a slave apparatus in the standby state without performing RIP, and a slave apparatus in the power saving mode consumes less power than the same slave apparatus in the standby state without performing RIP. Since the technique of switching a slave apparatus from the normal mode to the power saving mode, and switching back from the power saving mode to the normal mode is a general power saving technique, so that detail descriptions are skipped here.

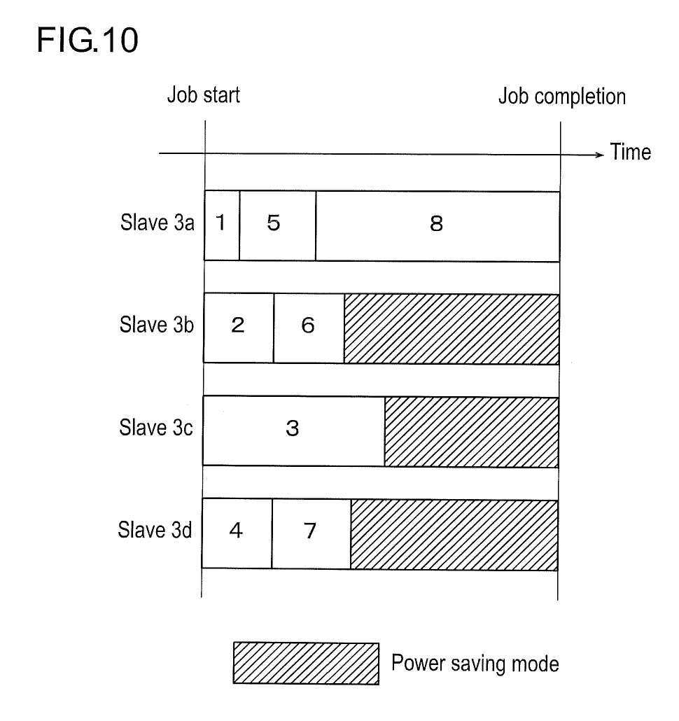

FIG. 10 is a diagram for describing the power saving effect of the distributed process according to the present embodiment.

As described above, the master apparatus 2 transmits the job completion notice to all the slave apparatuses 3a-3d, when it transmits the data of the last page of the print job to a slave apparatus. Upon receiving the job completion notice from the master apparatus 2, the slave apparatuses 3a-3d switch to the power saving mode in sequence as they complete the RIP. In case of FIG. 10, they switch to the power saving mode in the order of the second slave apparatus 3b, the fourth slave apparatus 3d, the third slave apparatus 3c, and the first slave apparatus 3a.

As can be seen from the above, according to the present embodiment, each slave apparatus is switched to the power saving mode independently without waiting for the completion of the RIP of the last page (8th page) of the print job. Therefore, there is no state where other slave apparatuses stand by without performing the RIP while one slave apparatus performs the RIP, so that the power consumed by the slave apparatuses during the execution of the print job is reduced.

### Second Embodiment

In the first embodiment, a case where the total number of pages (last page) of the print job is recognized by the master apparatus was described. In the present embodiment, a case where the total number of pages of the print job is not recognized by the master apparatus will be described. For example, if the communication between the PC 1a and the printer controller 5 is temporarily suspended due to a certain communication problem, the distributed process is initiated without recognizing the total number of pages of the print job by the master apparatus 2. In the present embodiment wherein the distributed process is executed without recognizing the total number of pages of the print job, the operating mode of the slave apparatus is switched in accordance with the number of pages of the image data waiting to be printed. Since the configuration of the image forming system of the present embodiment is identical to that of the first embodiment other than the fact that the operating mode of the slave apparatus is switched, the detail description of the configuration of the apparatus is omitted.

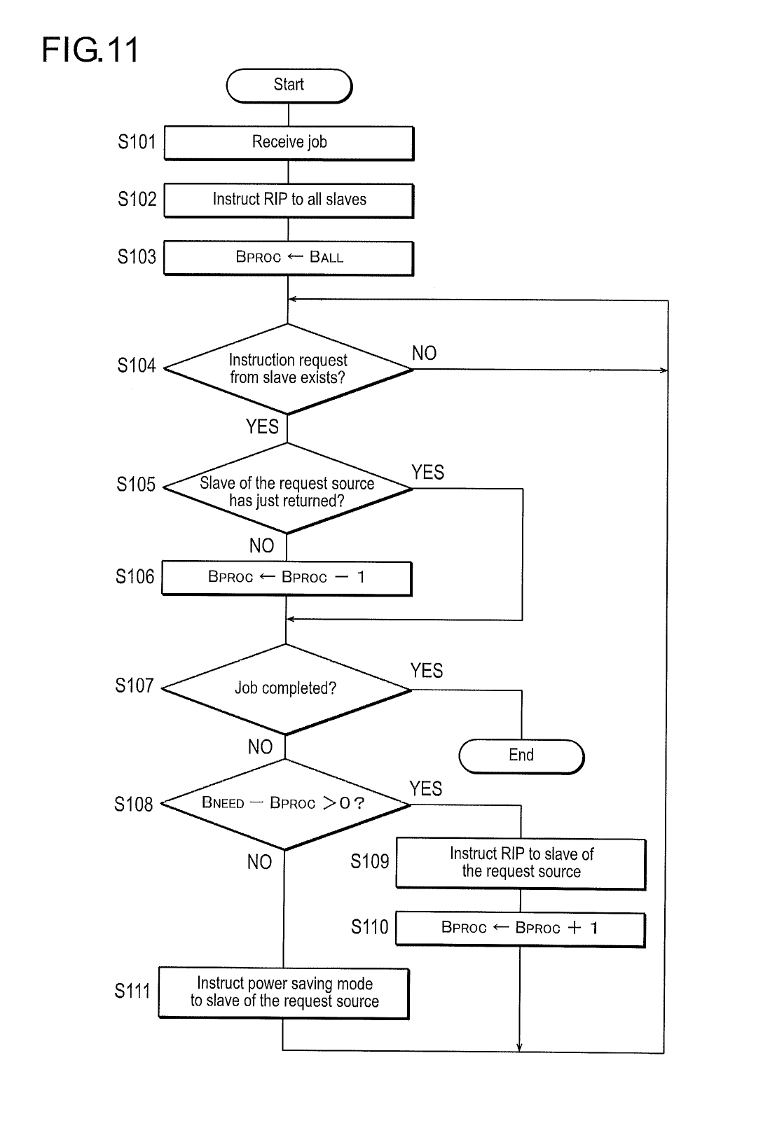

FIG. 11 is a flowchart showing the procedure of the distributed process according to the second embodiment of the present invention. The algorithm shown in the flowchart of FIG. 11 is stored as a program in the hard disk 24 of the master apparatus 2 and is executed by the CPU 21.

First, upon receiving the print job, the performance of the RIP is instructed to all the slave apparatuses 3a-3d (steps S101, S102). In the present embodiment, the data (PDL data) of the first page through the fourth page of the print job is transmitted to the four slave apparatuses 3a-3d. The slave apparatuses 3a-3d start to perform the RIP of the page assigned respectively to each of them.

Next, the number of slave blades currently performing the RIP B_{PROC} is set up as the total number of slaves B_{ALL} (step S103). In the present embodiment, the number of slave blades currently performing the RIP B_{PROC} that indicates the number of slave apparatuses performing the RIP is set up as the total number of slave apparatuses 3a-3d that are connected to the master apparatus 2 (i.e., 4).

Next, a judgment is made as to whether or not there exists an instruction request from the slave apparatus (step S104). The slave apparatus of the present embodiment is configured to request an instruction to the master apparatus 2, when it completes the RIP currently being performed, or when it returns back to the normal mode from the power saving mode. The details of the operation of the slave apparatuses will be described later.

If an instruction request from the slave apparatus does not exist (step S104: No), the program stands by until an instruction request from the slave apparatus is received. On the other hand, if an instruction request from the slave apparatus exists (step S104: Yes), a judgment is made as to whether or not the slave apparatus of the request source is a slave apparatus that has just returned to the normal mode (step S105). In the present embodiment, a judgment is made as to whether the slave apparatus that requested an instruction to the master apparatus 2 is a slave apparatus that has just returned to the normal mode, or a slave apparatus that has just completed the RIP. For example, it is possible to judge whether the slave apparatus of the request source is a slave apparatus that has just returned to the normal mode or not by storing the operation mode of each of the slave apparatuses 3a-3d on the master apparatus 2.

If it is judged that the slave apparatus of the request source is a slave apparatus that has just returned to the normal mode (step S105: Yes), the program moves to the process of step S107. On the other hand, if it is judged that the slave apparatus of the request source is not a slave apparatus that has just returned to the normal mode (step S105: No), the number of slave blades currently performing the RIP B_{PROC} is decremented by “1” (step S106).

Next, a judgment is made as to whether or not the print job is completed (step S107). More specifically, a judgment is made as to whether or not there is the data of the next page for which the RIP has not been performed. If it is judged that the print job is completed (step S107: Yes), the process is terminated.

On the other hand, if it is judged that the print job is not completed (step S107: No), a judgment is made as to whether or not the number of slave blades currently performing the RIP B_{PROC} is less than the number of slave blades needed B_{NEED} (step S108). Here, the number of slave blades needed B_{NEED} indicates the number of slave apparatuses needed to continue the printing process without affecting the printing speed (PPM) of the printer 4. The number of slave blades needed B_{NEED} is calculated based on the number of pages of the image data waiting to be printed, for which the printing output (image forming operation) by the printer 4 is not completed yet, among the image data obtained by performing RIP by the slave apparatuses (hereinafter referred to as “the number of remaining pages”) P. The process of calculating the number of blades needed B_{NEED} is described later.

If it is judged in the process shown in step S108 that the number of slave blades currently performing the RIP B_{PROC} is less than the number of blades needed B_{NEED} (step S108: Yes), the performance of the RIP is instructed to the slave apparatus of the request source (step S109). In the present embodiment, the data of the next page is transmitted to the slave apparatus that requested an instruction to the master apparatus 2 for the reason that the number of parallel RIP has not reached the required number.

Then, the number of slave blades currently performing the RIP B_{PROC} is incremented by “1” (step S110) and the program returns to the process of step S104.

On the other hand, if it is judged in the process shown in step S108 that the number of slave blades currently performing the RIP B_{PROC} is equal to or more than the number of blades needed B_{NEED} (step S108: No) the switch to the power saving mode is instructed to the slave apparatus of the request source (step S111) and the program returns to the process of step S104. In the present embodiment, the slave apparatus that requested an instruction to the master apparatus 2 is instructed to switch from the normal mode to the power saving mode for the reason that the number of parallel RIP has reached the required number.

As can be seen from the above, according to the flowchart shown in FIG. 11, a portion of the plurality of slave apparatuses 3a-3d is switched to the power saving mode while maintaining the necessary number of slave apparatuses needed for continuing the printing process without affecting the printing speed of the printer 4. More specifically, if the number of slave apparatuses currently performing the RIP exceeds the number of slave apparatuses needed, the slave apparatus that has completed the RIP is switched to the power saving mode. On the other hand, if the number of slave apparatuses currently performing the RIP is below the number of slave apparatuses needed, the data of the next page is transmitted to the slave apparatus that has completed the RIP. Moreover, the slave apparatus currently in the power saving mode is returned to the normal mode to perform the RIP as needed. The process of switching the slave apparatus currently in the power saving mode back to the normal mode will be described later.

With such a configuration, it is possible to switch a portion of the plurality of slave apparatuses 3a-3d to the power saving mode without affecting the printing speed of the printer 4. In other words, even in the case that the master apparatus 2 does not recognize the total number of pages of the print job, it is possible to reduce the electric power consumed by the slave apparatuses 3a-3d while maintaining the printing performance (printing speed) of the image forming system.

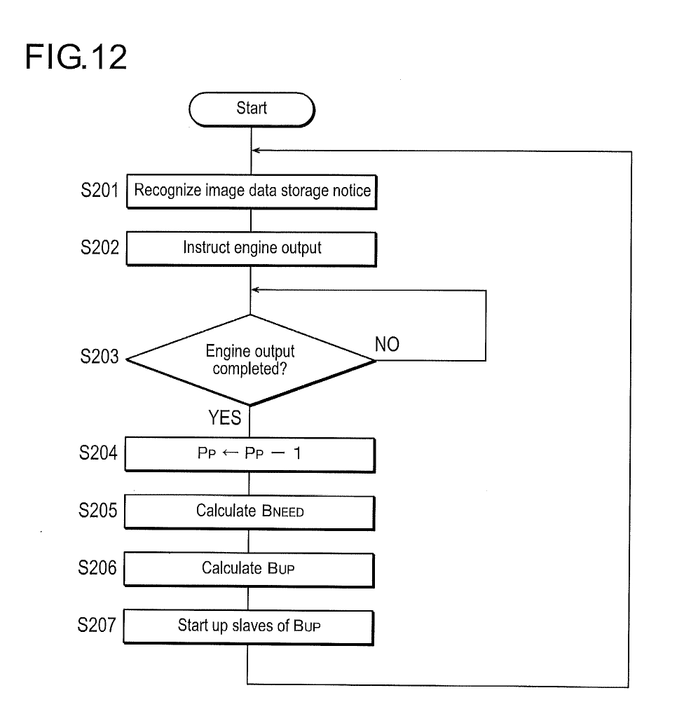

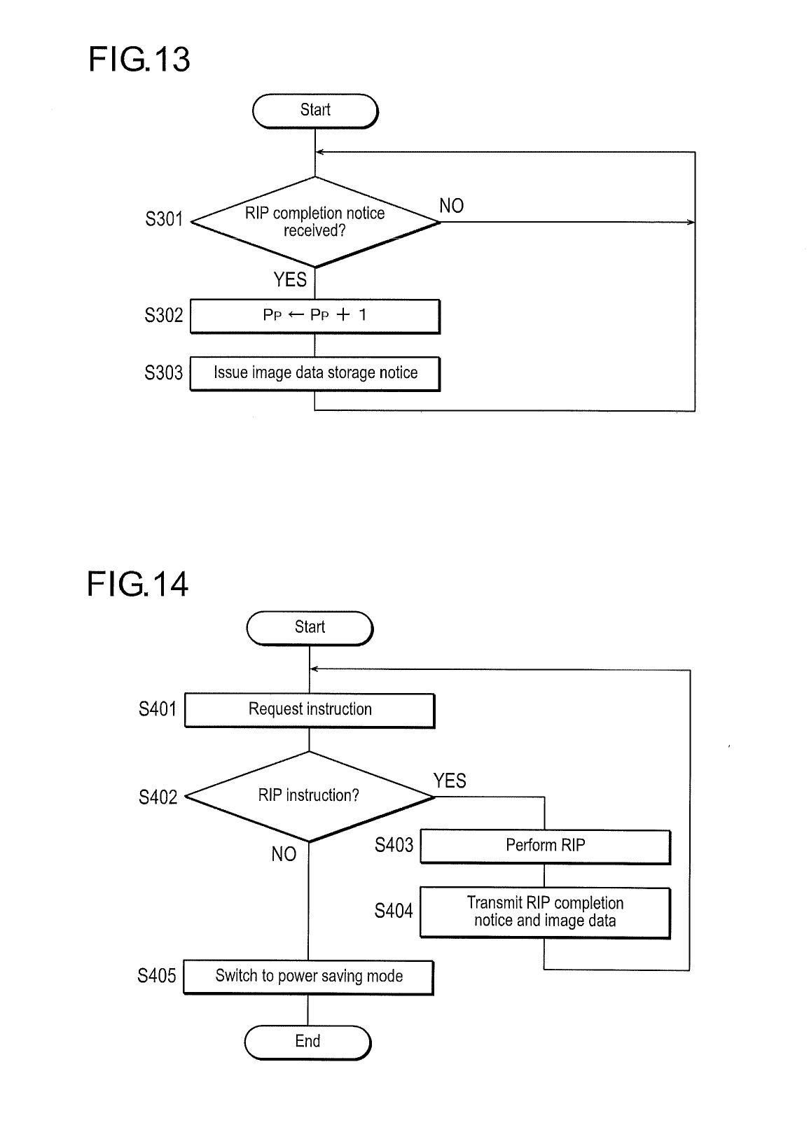

Next, the process of calculating the number of blades needed B_{NEED} and causing the slave apparatus to return from the power saving mode to the normal mode will be described below with reference to FIGS. 12 and 13.

FIG. 12 is a flowchart showing the procedure of the output process executed by the master apparatus. The algorithm shown in the flowchart of FIG. 12 is stored as a program in the hard disk 24 of the master apparatus 2 and is executed by the CPU 21. Moreover, the process of the flowchart shown in FIG. 12 is executed in a time-sharing manner along with the process of the flowchart shown in FIG. 11.

First, an image data storage notice is recognized (step S201). The fact that the image data obtained by performing RIP by the slave apparatus is stored in the RAM 23 is recognized by recognizing the image data storage notice.

Next, the output of the image data is instructed to the printer 4 (step S202). More specifically, the oldest image data among the image data stored in the RAM 23 waiting to be printed is transferred to the printer 4. Upon receiving the image data, the printer 4 forms an image based on the image data on a sheet of paper.

Next, a judgment is made as to whether or not the printing output is completed (step S203). When the printer 4 completes the printing output of one page, it is judged that the printing output is completed.

If the printing output is not completed (step S203: No), the program stands by until the printing output is completed. On the other hand, if the printing output is completed (step S203: Yes), the number of remaining pages P_{P} is decremented by “1” (step S204). As mentioned above, the number of remaining pages P_{P} indicates the number of pages of the image data yet to be printed by the printer 4.

Next, the number of slave blades needed B_{NEED} is calculated (step S205). The number of slave blades needed B_{NEED} is calculated based on the following formulas (1) and (2):

B_{NEED}=B_{ALL}−(P_{P}−B_{TH}) (1)

(when P_{P}>B_{TH})

B_{NEED}=B_{ALL} (2)

(when P_{P} B_{TH})

where B_{TH} is a predetermined threshold value, and is set to a specific value (e.g. 2) in order to assure a certain amount of image data waiting to be printed to remain during the execution of the distributed process.

After the number of slave blades needed B_{NEED} is calculated in the process shown in step S205, the number of startup slave blades B_{UP} is calculated (step S206). In the present embodiment, the number of startup slave blades B_{UP} that indicates the number of slave apparatus to be started is calculated by subtracting the number of slave blades currently performing the RIP B_{PROC} from the number of slave blades needed B_{NEED} calculated in the process shown in step S205.

Then, the slave apparatuses of the number of startup slave blades B_{UP} are started up (step S207), and the program returns to the process of step S201. In the present embodiment, the slave apparatuses in the power saving mode return to the normal mode as the specified startup signal is transmitted by the master apparatus 2.

FIG. 13 is a flowchart showing the procedure of the image data reception process executed by the master apparatus. The algorithm shown in the flowchart of FIG. 13 is stored as a program in the hard disk 24 of the master apparatus 2 and is executed by the CPU 21. The process of the flowchart shown in FIG. 13 is executed in a time-sharing manner along with the processes of the flowcharts shown in FIGS. 11 and 12.

First, a judgment is made as to whether or not the RIP completion notice is received from the slave apparatus (step S301). In the present embodiment, the RIP completion notice is transmitted from the slave apparatus to the master apparatus 2 when the image data is transmitted from the slave apparatus to the master apparatus 2.

If the RIP completion notice is not received from the slave apparatus (step S301: No), the program stands by until the RIP completion notice is received from the slave apparatus. On the other hand, if the RIP completion notice is received from the slave apparatus (step S301: Yes), the number of remaining pages P_{P} is incremented by “1” (step S302).

Then, the image data storage notice is issued (step S303), and the program returns to the process of step S301. The image data storage notice is recognized by the process of step S201 of FIG. 12.

As can be seen from the above, according to the processes of the flowcharts shown in FIGS. 12 and 13, the number of remaining pages P_{P} is updated according to the progress status of the print job. The number of slave blades needed B_{NEED} is calculated from the number of remaining pages P_{P} and the threshold value B_{TH}. If the number of slave apparatuses currently performing the RIP is less than the number of slave blades needed B_{NEED}, the slave apparatus in the power saving mode returns to the normal mode and performs the RIP. On the other hand, if the number of slave apparatuses currently performing the RIP exceeds the number of slave blades needed B_{NEED}, the slave apparatus that has completed the RIP is switched to the power saving mode (see step S111 of FIG. 11).

Next, the operation of the slave apparatus according to the present embodiment will be described below with reference to FIG. 14.

FIG. 14 is a flowchart showing the procedure of the RIP process executed by the slave apparatuses. The algorithm shown in the flowchart of FIG. 14 is stored as a program in the hard disk 34 of each of the slave apparatuses 3a-3d and is executed by the CPU 31.

First, an instruction request is issued to the master apparatus 2 (step S401). In the present embodiment, an instruction is requested to the master apparatus 2 by a slave apparatus that has just returned to the normal mode from the power saving mode, or a slave apparatus that has just completed the RIP.

Upon receiving an instruction from the master apparatus 2 in response to such an instruction request, a judgment is made as to whether or not the instruction is a RIP instruction (step S402). In the present embodiment, a judgment is made as to whether the instruction from the master apparatus 2 is a RIP instruction that instructs a performance of the RIP, or a power saving switch instruction that instructs a switch to the power saving mode.

If the instruction from the master apparatus 2 is a RIP instruction (step S402: Yes), the RIP is performed (step S403). In the present embodiment, the RIP is performed on the data of one page transmitted by the master apparatus 2.

When the RIP is completed, the RIP completion notice and the image data are transmitted to the master apparatus 2 (step S404), and the program returns to the process of step S401.

On the other hand, if the instruction from the master apparatus 2 is not a RIP instruction in the process shown in step S402 (step S402: No), the operating mode is switched to the power saving mode assuming that the instruction from the master apparatus 2 is the power saving switch instruction (step S405), and the process is terminated. As the slave apparatus is switched to the power saving mode, the power supply to the CPU 31 of the slave apparatus is suspended.

As can be seen from the above, according to the process of the flowchart shown in FIG. 14, the slave apparatus that has just returned from the power saving mode or just completed the RIP requests the master apparatus for an instruction. Then, the slave apparatus performs the RIP of one page or switches to the power saving mode in accordance with an instruction from the master apparatus.

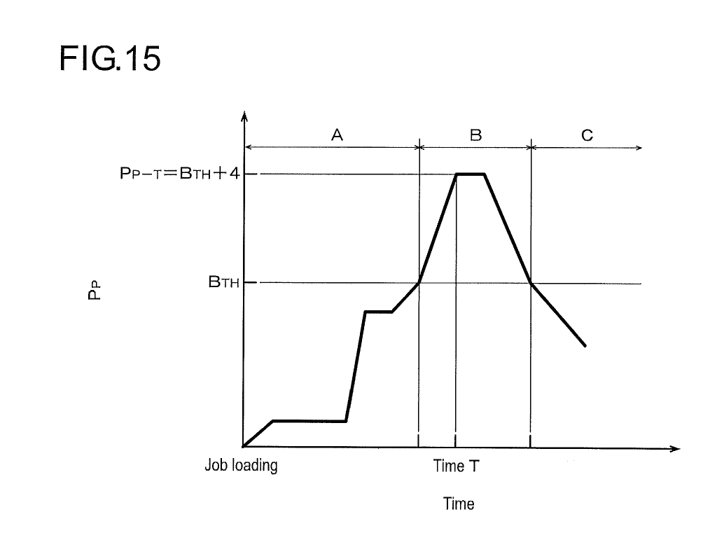

FIG. 15 is a diagram showing an example of the changes of the number of remaining pages in the distributed process according to the present embodiment. The vertical axis of FIG. 15 represents the number of remaining pages and the horizontal axis represents time.

Immediately after the start of the execution of a print job, all the slave apparatuses perform the RIP (see the area A of FIG. 15). As time goes by, after the start of the execution of the print job, the number of remaining pages P_{P} increases.

When the number of remaining pages P_{P} exceeds the threshold value B_{TH}, the same number of slave apparatuses as the number of pages that exceeds the threshold value B_{TH} are switched to the power saving mode (see the area B of FIG. 15). For example, if the number of remaining pages P_{P-T} at the time T is B_{TH}+4, B_{ALL}−4 is calculated as the number of blades needed B_{NEED-T} at the time T according to the formula (1) shown above. Consequently, four slave apparatuses are switched to the power saving mode.

Later, when the number of remaining pages P_{P} becomes again less than the threshold value B_{TH}, all the slave apparatuses perform the RIP according to the formula (2) shown above (see the area C of FIG. 15).

As can be seen from the above, according to the present embodiment, when the number of remaining pages P_{P} exceeds the predetermined threshold value B_{TH}, the same number of slave apparatuses as the number of pages that exceeds the threshold value B_{TH} switch to the power saving mode. On the other hand, if the number of remaining pages P_{P} becomes less than the threshold value B_{TH}, all the slave apparatuses perform the RIP. In other words, the operating mode of the slave apparatuses 3a-3d is switched so that the number of remaining pages P_{P} does not become “0” depending on the progress status of the print job. With such a configuration, it is possible to reduce the power consumed in the image forming system while securely maintaining the printing performance (printing speed) of the image forming system.

### Third Embodiment

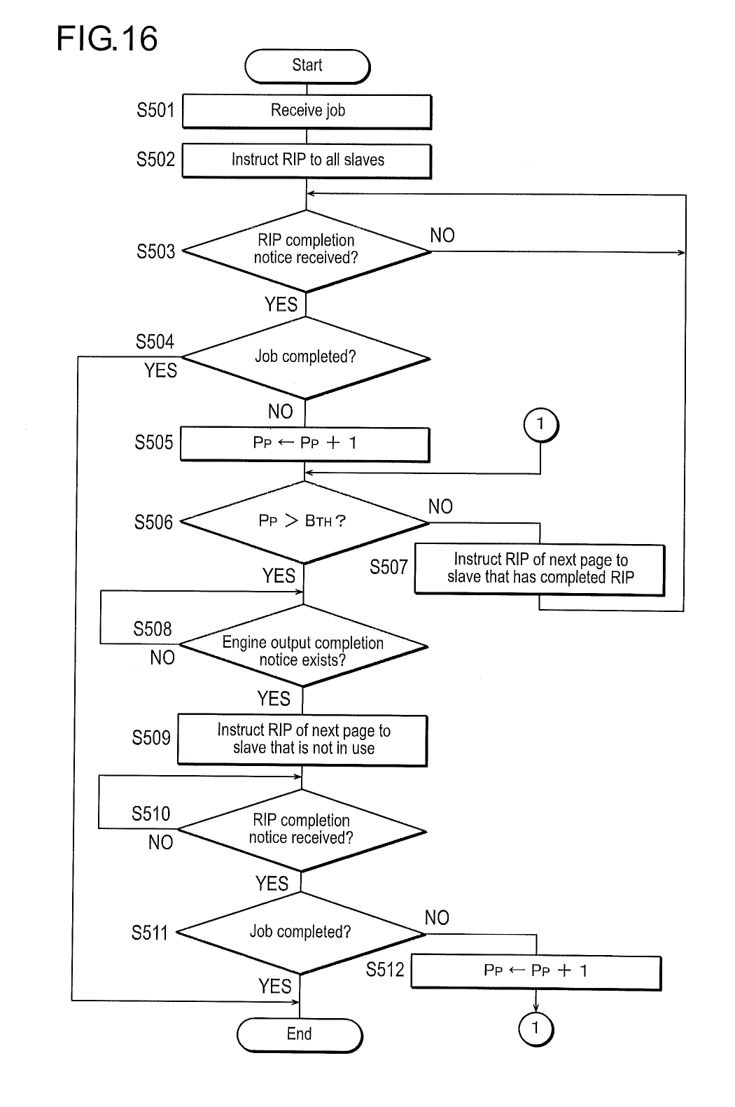

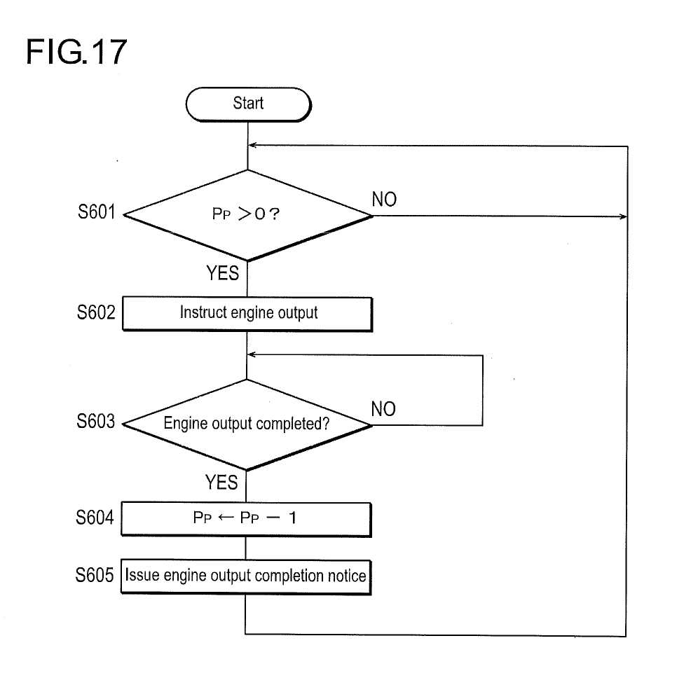

The third embodiment of the present invention will be described below with reference to FIGS. 16 and 17. The present embodiment is an embodiment wherein the RIP of one page is performed by one slave apparatus each time the printing output of one page is completed, when the number of remaining pages exceeds the threshold value. The slave apparatus of the present embodiment is configured to switch to the power saving mode automatically when it does not receive a RIP instruction from the master apparatus.

FIG. 16 is a flowchart showing the procedure of the distributed process according to the third embodiment of the present invention. The algorithm shown in the flowchart of FIG. 16 is stored as a program in the hard disk 24 of the master apparatus 2 and is executed by the CPU 21.

First, upon receiving the print job, the performance of the RIP is instructed to all the slave apparatuses 3a-3d (steps S501, S502).

Next, a judgment is made as to whether or not the RIP completion notice is received from the slave apparatus (step S503). If the RIP completion notice is not received from the slave apparatus (step S503: No), the program stands by until the RIP completion notice is received from the slave apparatus.

On the other hand, if the RIP completion notice is received from the slave apparatus (step S503: Yes), a judgment is made as to whether or not the print job is completed (step S504). If it is judged that the print job is completed (step S504: Yes), the process is terminated.

On the other hand, if it is judged that the print job is not completed (step S504: No), the number of remaining pages P_{P} is incremented by “1” (step S505).

Next, a judgment is made as to whether or not the number of remaining pages P_{P} is more than the threshold value B_{TH} (e.g., 2) (step S506).

If it is judged that the number of remaining pages P_{P} is less than or equal to the threshold value B_{TH} (step S506: No), the performance of the RIP is instructed to the slave apparatus that has completed the RIP (step S507), and the program returns to the process of step S503. In the present embodiment, the data of the next page is transmitted to a slave apparatus that has completed the RIP.

On the other hand, if it is judged that the number of remaining pages P_{P} is more than the threshold value B_{TH} (step S506: Yes), a judgment is made as to whether or not there exists an engine output completion notice (step S508). In the present embodiment, a judgment is made as to whether or not there is an engine output completion notice that indicates that the printing output of one page by the printer 4 is completed.

If it is judged that the engine output completion notice does not exist (step S508: No), the program stands by until the engine output completion notice is issued. During this period of time, the slave apparatus that has completed the RIP switches from the normal mode to the power saving mode automatically.

On the other hand, if it is judged that the engine output completion notice exists (step S508: Yes), the performance of the RIP is instructed to a slave apparatus that is not in use (step S509). In the present embodiment, the data of the next page is transmitted to a slave apparatus that is in the power saving mode. The slave apparatus of the present embodiment has the WOL (Wake On LAN) function so that it can immediately return from the power saving mode to the normal mode and start the RIP upon receiving the data.

Next, a judgment is made as to whether or not the RIP completion notice is received from the slave apparatus (step SS10). If the RIP completion notice is not received from the slave apparatus (step SS10: No), the program stands by until the RIP completion notice is received.

On the other hand, if the RIP completion notice is received from the slave apparatus (step SS10: Yes), a judgment is made as to whether or not the print job is completed (step S511). If it is judged that the print job is completed (step S511: Yes), the process is terminated.

On the other hand, if it is judged that the print job is not completed (step S511: No), the number of remaining pages P_{P} is incremented by “1” (step S512), and the program returns to the process of step S506.

As can be seen from the above, when the number of remaining pages P_{P} exceeds the threshold value B_{TH}, a slave apparatus performs the RIP of one page each time the printing output of one page is completed, according to the process of the flowchart shown in FIG. 16. With such a configuration, it is possible to cause the unnecessary slave apparatuses to switch to the power saving mode while maintaining the number of remaining pages P_{P} equal to or more than the threshold value B_{TH}.

FIG. 17 is a flowchart showing the procedure of the output process executed by the master apparatus. The algorithm shown in the flowchart of FIG. 17 is stored as a program in the hard disk 24 of the master apparatus 2 and is executed by the CPU 21. The process of the flowchart shown in FIG. 17 is executed in a time-sharing manner along with the process of the flowchart shown in FIG. 16.

First, a judgment is made as to whether or not the number of remaining pages P_{P} is more than “0” (step S601). If it is judged that the number of remaining pages P_{P} is less than or equal to “0” (step S601: No), the program stands by until the number of remaining pages P_{P} becomes more than “0”.

On the other hand, if it is judged that the number of remaining pages P_{P} is more than “0” (step S601: Yes), the output of the image data is instructed to the printer 4 (step S602). In the present embodiment, the oldest image data among the image data stored in the RAM 23 is transferred to the printer 4.

Next, a judgment is made as to whether or not the printing output is completed (step S603). If the printing output is not completed (step S603: No), the program stands by until the printing output is completed. On the other hand, if the printing output is completed (step S603: Yes), the number of remaining pages P_{P} is decremented by “1” (step S604).

Then, the engine output completion notice is issued (step S605), and the program returns to the process of step S601. The engine output completion notice is recognized by the process of step S508 of FIG. 16.

As can be seen from the above, the engine output completion notice is issued each time the printing output of one page is completed, according to the process of the flowchart shown in FIG. 17. As the engine output completion notice is issued, the RIP of the next page is instructed to a slave apparatus that is not in use.

As can be seen from the above, according to the present embodiment, the RIP of one page is instructed to a slave apparatus each time the printing output of one page by the printer is completed, when the number of remaining pages P_{P} exceeds a predetermined threshold value B_{TH}. The remaining slave apparatuses that are not instructed to perform the RIP switch to the power saving mode automatically. With such a configuration, it is possible to reduce the power consumed in the image forming system while maintaining the printing performance (printing speed) of the image forming system.

The present invention shall not be limited to the first through third embodiments described above, but also can be changed in various ways within the scope of the claims.

For example, in the third embodiment described above, the slave apparatus is configured to switch to the power saving mode automatically when it does not receive an instruction from the master apparatus. However, the slave apparatus can be configured to switch to the power saving mode upon receiving a power saving switch instruction from the master apparatus as in the first and second embodiments.

Also, the first through third embodiments were described referring a case where the RIP is performed by a plurality of slave apparatuses splitting the print job by page. However, the unit of splitting the print job for performing the RIP is not limited to the page, but rather the RIP can be performed by object.

Moreover, in the first through third embodiments described above, the power supply to the CPU is suspended during the power saving mode (Suspended To RAM). However, a similar effect can be achieved by the CPU clock-down, i.e., by reducing the drive frequency of the CPU, during the power saving mode. The power saving mode applied to a plurality of slave apparatuses is not limited to one kind but rather various other kinds of power saving modes can be used considering the power consumption amount and the return time.

The units and method of conducting various processes in the image processing system according to the first through third embodiment can be realized either by a dedicated hardware circuit, or by a programmed computer. The above program can be provided either by a computer readable recording medium such as a flexible disk or CD-ROM, or on-line via a network such as the Internet. In such a case, the program recorded on the computer readable recording medium is normally transferred to and stored on a storage unit such as a hard disk. Also, the above program can be either provided as a standalone application software program or can be built into the software of an image processing system as one of its function.

What is claimed is:

1. An image processing system having a plurality of image processing apparatuses for performing raster image processing of a print job in a distributed manner, and an image processing control apparatus that controls said plurality of image processing apparatuses, wherein
each of said image processing apparatuses comprises:
a switching unit configured to switch the operating mode of the image processing apparatus from a normal mode to a power saving mode whose power consumption is lower than that of said normal mode, and
said image processing control apparatus comprises:
a control unit configured to execute a control for causing unnecessary image processing apparatuses among said plurality of image processing apparatuses to switch from said normal mode to said power saving mode depending on the progress status of said print job.

2. The image processing system as claimed in claim 1, wherein
said image processing control apparatus further comprises: a transmission unit configured to transmit the image data obtained by performing raster image processing by said image processing apparatuses, to an image forming apparatus, and
said control unit executes said control based on the number of pages of the image data waiting for image forming operation, for which the image forming operation by said image forming apparatus is not yet completed.

3. The image processing system as claimed in claim 2, wherein
said control unit causes the same number of said image processing apparatuses as the number of pages exceeding predetermined threshold value to switch to said power saving mode, when said number of pages of the image data exceeds said threshold value.

4. The image processing system as claimed in claim 2, wherein
said control unit instructs one image processing apparatus to perform raster image processing of one page each time the image forming operation of one page by said image forming apparatus is completed and causes other image processing apparatuses to switch to said power saving mode, when said number of pages of the image data exceeds predetermined threshold value.

5. The image processing system as claimed in claim 1, wherein
each of said image processing apparatuses is configured to switch to said power saving mode when an instruction to perform raster image processing is not received from said image processing control apparatus, and
said image processing control apparatus causes said unnecessary image processing apparatuses to switch to said power saving mode by not instructing said image processing apparatuses to perform raster image processing.

6. The image processing system as claimed in claim 1, wherein
each of said image processing apparatuses is configured to switch to said power saving mode when an instruction to switch to said power saving mode is received from said image processing control apparatus, and
said image processing control apparatus causes said unnecessary image processing apparatuses to switch to said power saving mode by instructing said image processing apparatuses to switch to said power saving mode.

7. The image processing system as claimed in claim 1, wherein
said control unit instructs all the image processing apparatuses to switch to said power saving mode, when said control unit instructs one image processing apparatus to perform raster image processing of the last page of said print job, and
each of said image processing apparatuses switches to said power saving mode after completing raster image processing that is currently being performed, when the instruction to switch to said power saving mode is received.

8. An image processing control apparatus to be used in an image processing system having a plurality of image processing apparatuses for performing raster image processing of a print job in a distributed manner, and an image processing control apparatus that controls said plurality of image processing apparatuses, wherein
the operating mode of said image processing apparatuses is configured to switch from a normal mode to a power saving mode whose power consumption is lower than that of said normal mode, and
said image processing control apparatus comprising:
a control unit configured to execute a control for causing unnecessary image processing apparatuses among said plurality of image processing apparatuses to switch from said normal mode to said power saving mode depending on the progress status of said print job.

9. The image processing control apparatus as claimed in claim 8, further comprising:
a transmission unit configured to transmit the image data obtained by performing raster image processing by said image processing apparatuses, to an image forming apparatus, wherein
said control unit executes said control based on the number of pages of the image data waiting for image forming operation, for which the image forming operation by said image forming apparatus is not yet completed.

10. The image processing control apparatus as claimed in claim 9, wherein
said control unit causes the same number of said image processing apparatuses as the number of pages exceeding predetermined threshold value to switch to said power saving mode, when said number of pages of the image data exceeds said threshold value.

11. The image processing control apparatus as claimed in claim 9, wherein
said control unit instructs one image processing apparatus to perform raster image processing of one page each time the image forming operation of one page by said image forming apparatus is completed and causes other image processing apparatuses to switch to said power saving mode, when said number of pages of the image data exceeds predetermined threshold value.

12. The image processing control apparatus as claimed in claim 8, wherein
each of said image processing apparatus is configured to switch to said power saving mode when an instruction to perform raster image processing is not received from said image processing control apparatus, and
said image processing control apparatus causes said unnecessary image processing apparatuses to switch to said power saving mode by not instructing said image processing apparatuses to perform raster image processing.

13. The image processing control apparatus as claimed in claim 8, wherein
each of said image processing apparatus is configured to switch to said power saving mode when an instruction to switch to said power saving mode is received from said image processing control apparatus, and
said image processing control apparatus causes said unnecessary image processing apparatuses to switch to said power saving mode by instructing said image processing apparatuses to switch to said power saving mode.

14. The image processing control apparatus as claimed in claim 8, wherein
said control unit instructs all the image processing apparatuses to switch to said power saving mode, when said control unit instructs one image processing apparatus to perform raster image processing of the last page of said print job, and
each of said image processing apparatuses switches to said power saving mode after completing raster image processing that is currently being performed, when the instruction to switch to said power saving mode is received.
